(19) United States
(12) Patent Application Publication
(10) Pub. No.: US 2004/0026878 A1
(43) Pub. Date: Feb. 12, 2004

(54) Chuck device for miniature tool bits

(76) Inventors: Tsai-Ching Chen, Chang Hua Hsien (TW); Chiu-Man Chang-Kao, Taichung Hsien (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/634,193

(22) Filed: Aug. 4, 2003

Related U.S. Application Data
(63) Continuation-in-part of application No. 10/104,118, filed on Mar. 22, 2002, now Pat. No. 6,637,755.

(51) Int. Cl. B23B 31/107

(52) U.S. Cl. 279/75

(57) ABSTRACT

A chuck device is provided for a tool bit with an annual groove. The chuck device includes a socket defining a chamber for receiving the tool bit and at least one aperture communicated with the chamber. A spindle extends from the socket. At least one ball is received in the at least one aperture for entering the annular groove of the tool bit. A first ring is mounted on the socket. A first elastic element is mounted on the socket. A sleeve includes a chamber defined therein so as to form an internal face, an annular groove defined in the internal face and an annular rib formed on the internal face. The sleeve is mounted on the socket so that the elastic element is compressed between the ring and the annular rib, thus biasing the sleeve. A second ring is fit in the sleeve for abutting the first ring so as to retain the sleeve on the socket. A second elastic element is put in the chamber of the socket for pushing the tool bit.

### CROSS-REFERENCE

The present patent application is a continuation in part of U.S. patent application Ser. No. 10/104,118 filed on Mar. 22, 2002 and entirely incorporated therein.

### FIELD OF INVENTION

The present invention relates to a chuck device for engagement with miniature tool bits.

### BACKGROUND OF INVENTION

According to U.S. patent application Ser. No. 10/104,118, a chuck device includes a socket 10, at least one ball 14, a first ring 17, an elastic element 24, a sleeve 20, a second ring 25 and a spindle 40. The socket 10 defines a chamber 11. The sleeve 20 is mounted on the socket 10. The sleeve 20 is moved relative to the socket 10 from a locking position to a releasing position according to the sleeve 20 presses the ball 14 into the chamber 11 or releases the ball 14 from the chamber 11. The pusher 30 can move in the chamber 11 for receiving a miniature tool bit 50. The spindle 40 is securely pressed into the chamber 13 of the socket 10. This chuck device therefore needs a lot of components and assembly of these components is complicated.

The present invention is therefore intended to obviate or at least alleviate the problems encountered in prior art.

### SUMMARY OF INVENTION

The primary objective of the present invention is to provide a chuck device that includes a simple structure.

According to the present invention, a chuck device is provided for a tool bit with an annual groove. The chuck device includes a socket defining a chamber for receiving the tool bit and at least one aperture communicated with the chamber. A spindle extends from the socket. At least one ball is received in the at least one aperture for entering the annular groove of the tool bit. A first ring is mounted on the socket. A first elastic element is mounted on the socket. A sleeve includes a chamber defined therein so as to form an internal face, an annular groove defined in the internal face and an annular rib formed on the internal face. The sleeve is mounted on the socket so that the elastic element is compressed between the ring and the annular rib, thus biasing the sleeve. A second ring is fit in the sleeve for abutting the first ring so as to retain the sleeve on the socket. A second elastic element is put in the chamber of the socket for pushing the tool bit.

Other objects, advantages, and novel features of the invention will become more apparent from the following detailed description when taken in conjunction with the attached drawings.

### BRIEF DESCRIPTION OF DRAWINGS

The present invention will be described through detailed illustration of embodiments referring to the attached drawings.

FIG. 1 is a perspective view of a chuck device for tool bits according to a first embodiment of the present invention.

FIG. 2 is an exploded view of the chuck device of FIG. 1.

FIG. 3 is a cross-sectional view of the chuck device of FIG. 1.

FIG. 4 is similar to FIG. 3 except for showing the chuck device engaged with a miniature tool bit.

FIG. 5 is similar to FIG. 3 except for showing the miniature tool bit disengaged from the chuck device.

FIG. 6 is an exploded view of the chuck device for tool bits according to a second embodiment of the present invention.

### DETAILED DESCRIPTION OF EMBODIMENTS

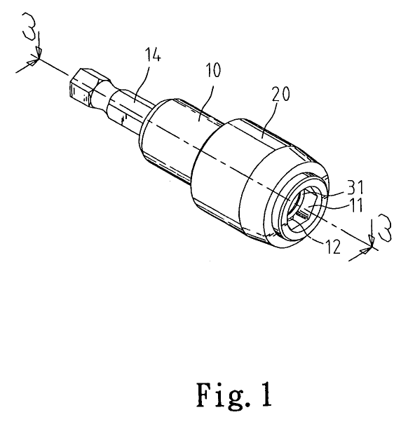

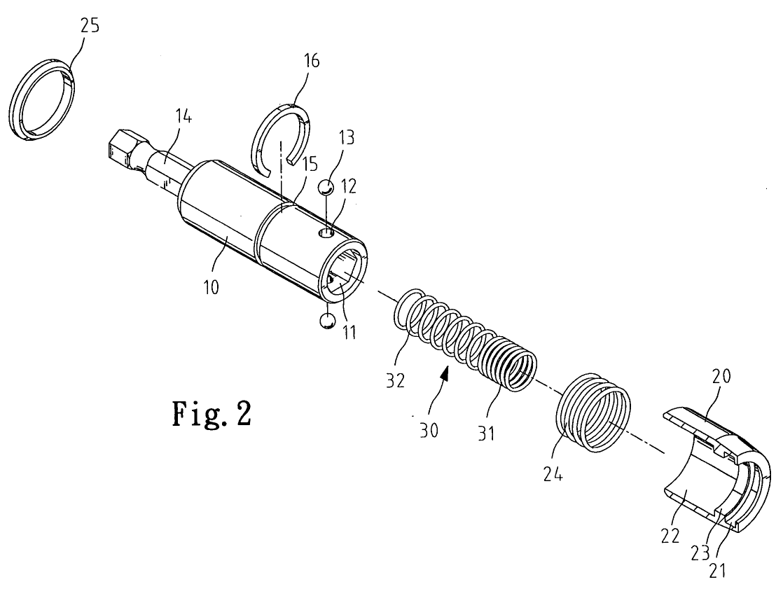

Referring to FIGS. 1-5, according to a first embodiment of the present invention, a chuck device includes a socket 10, a sleeve 20, an elastic element 24, an elastic element 30, a spindle 14, and a ring 25.

The socket 10 includes a first end and a second end. The first end of the socket 10 axially defines a chamber 11 that includes a plurality of facets and transversely defines two apertures 12 in communication with the chamber 11. Each of the apertures 12 extends through one of the facets of the chamber 11. A ball 13 is received in each of the apertures 12. The socket 10 includes an annular groove 15 defined in an external surface thereof. A C-ring 16 is received in the annular groove 15. The spindle 14 extends from the second end of the socket 10. The spindle 14 may be connected with a handle (not shown) or a driving element of a pneumatic or electric device (not shown).

The sleeve 20 includes a first end and a second end, an annular groove 21 defined in an internal surface of the first end thereof and an annular rib 23 formed on the internal surface of the first end thereof. The annular groove 21 and the annular rib 23 are arranged next to each other. A chamber 22 is defined in the second end of the socket 10 for receiving the first end of the socket 10. An elastic element 24 and the sleeve 20 are mounted on the first end of the socket 10. The elastic element 24 is compressed between the C-ring 16 and the annular rib 23 of the sleeve 20. Thus, the sleeve 20 is biased by the elastic element 24.

The elastic element 30 includes a first end 31 and a second end 32. The pitch of the first end 31 is greater than that of the second end 32, i.e., the first end 31 is denser than the second end 32. The elastic element 30 is received in the chamber 11 of the socket 10. The first end 31 of the elastic element 30 of the present invention is equivalent of the pusher 30 of U.S. patent application Ser. No. 10/104,118. The second end 31 of the elastic element 30 of the present invention is equivalent of the spring 45 of U.S. patent application Ser. No. 10/104,118. However, the structure of the elastic element 30 of the present invention is much simpler than that is comprised of the pusher 30 and the spring 45.

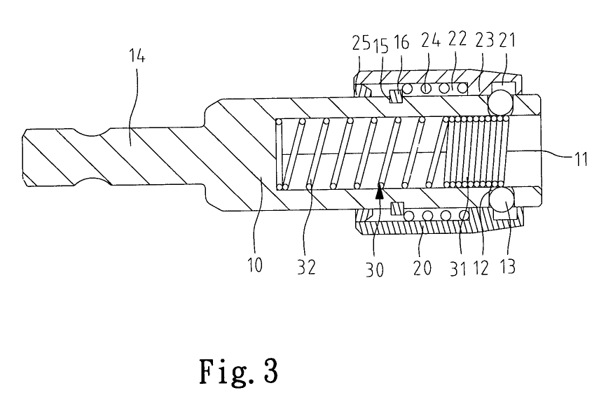

Referring to FIG. 3, the sleeve 20 is mounted on the first end of the socket 10. The sleeve 20 is biased by means of the elastic element 24. The balls 13 are pushed into the annular groove 21 by means of the first end 31 of the elastic element 30. The annular rib 23 abuts the balls 13 so as to avoid the sleeve 20 escaping the chamber 11 of the socket 10.

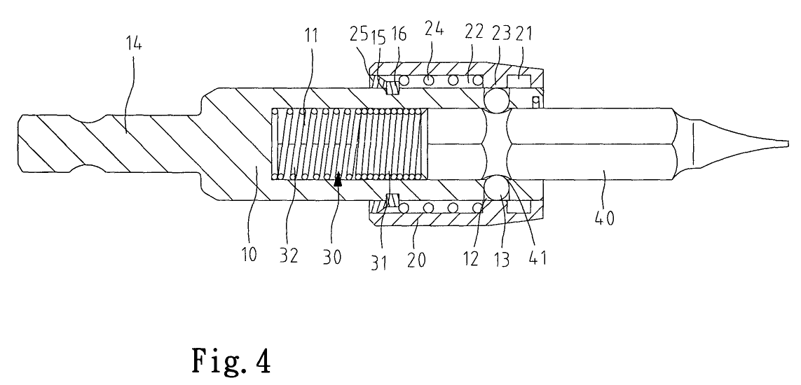

Referring to FIG. 4, a miniature tool bit 40 includes six facets corresponding to that of the chamber 11 of the socket 10 so that the socket 10 can drive the miniature tool bit 40. The miniature tool bit 40 includes an annular groove defined therein. As the miniature tool bit 40 is inserted in the chamber 11 of the socket 10, the spring 30 (particularly its second end 32) is compressed by means of the miniature tool bit 40. The balls 13 are pushed into the annual groove 41 of the miniature tool bit 40 by means of the annual rib 23 so as to prevent the miniature tool bit 40 from escaping the chamber 11 of the socket 10. A ring 25 is fit in the chamber 22 of the sleeve 20. The ring 25 can abut the C-ring 16 in order to retain the sleeve 20 on the socket 10.

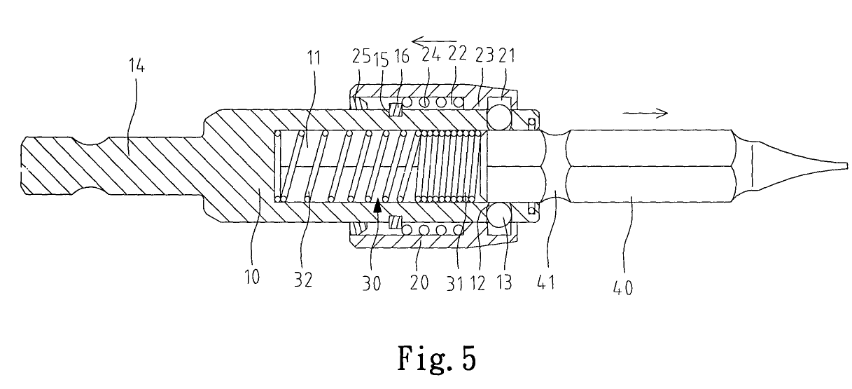

FIG. 5 shows disengagement of the miniature tool bit 40 from the chuck device. The sleeve 20 is moved to the left relative to the socket 10 so that the annular groove 21 is aligned with the balls 13. The balls 13 enter the annular groove 21, i.e., leave the annular groove 41. Thus, the miniature tool bit 40 is allowed to leave the chuck device. The elastic element 30 pushes the miniature tool bit 40 out of the chamber 11.

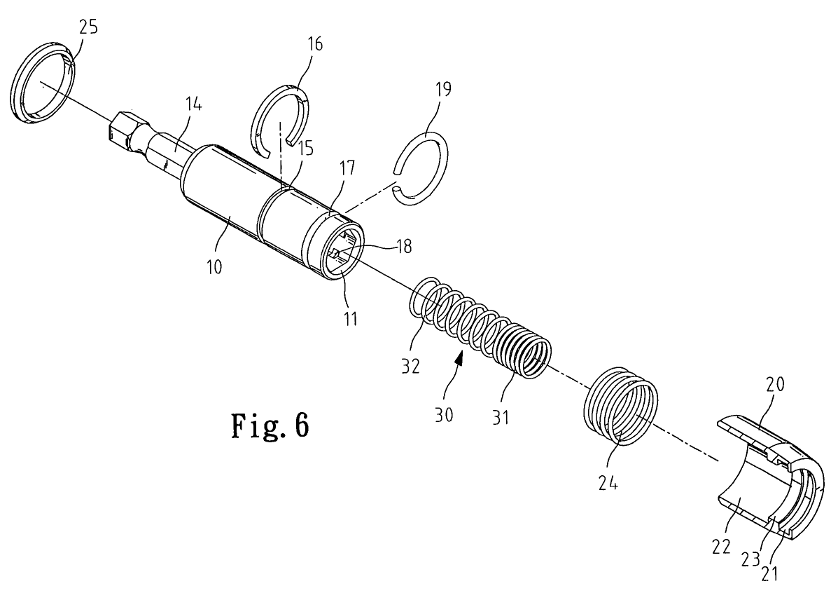

FIG. 6 shows a second embodiment according to the present invention. The second embodiment is identical to the first embodiment except for including a C-ring 19 instead of the balls 13. An annular groove 17 is accordingly defined in the first end of the socket 10 for receiving the C-ring 19. The annular groove 17 is communicated with the chamber 11 through apertures 18 each defined in a corner of the chamber 11. The C-ring 19 can enter the annular groove 41 through the apertures 18.

The present invention has been described through detailed illustration of two embodiments. Those skilled in the art can derive variations from the embodiments without departing from the scope of the present invention. Therefore, the embodiments shall not limit the scope of the present invention defined in the claims.

What is claimed is:

1. A chuck device for a tool bit with an annual groove, the chuck device including:
a socket defining a chamber for receiving the tool bit and at least one aperture communicated with the chamber;
a spindle extending from the socket;
at least one ball received in the at least one aperture for entering the annular groove of the tool bit;
a sleeve including a chamber in which the socket is movably inserted and an annular groove communicated with the chamber for receiving the at least one ball;
a first elastic element compressed between the socket and the sleeve; and
a second elastic element put in the chamber of the socket for pushing the tool bit.

2. The chuck device according to claim 1 including a ring attached to the socket, wherein the first elastic element is compressed between the ring and the sleeve.

3. The chuck device according to claim 2 wherein the sleeve includes an annular rib formed on an internal face, wherein the elastic element is compressed between the ring and the annular rib.

4. The chuck device according to claim 2 including a ring fit in the sleeve for abutting the ring attached to the socket so as to retain the sleeve on the socket.

5. The chuck device according to claim 1 wherein the socket includes two apertures each defined in one of the facets of the chamber, and a ball is received in each of the apertures.

6. The chuck device according to claim 1 wherein the first ring is a C-ring received in an annular groove defined in an external surface of the socket.

7. The chuck device according to claim 1 wherein the second elastic element includes a first section and a second section for contact with the tool bit.

8. The chuck device according to claim 7 wherein the first section of the second elastic element is denser than the second section of the second elastic element.

9. A chuck device for a tool bit with an annual groove, the chuck device including:
a socket defining a chamber for receiving the tool bit, an annular groove in an external face and at least one aperture through which the chamber is communicated with the annular groove;
a spindle extending from the socket;
a C-ring received in the annular groove of the socket for entering the annular groove of the tool bit through the at least one aperture;
a sleeve including a chamber in which the socket is movably inserted and an annular groove communicated with the chamber for receiving the C-ring;
a first elastic element compressed between the socket and the sleeve; and
a second elastic element put in the chamber of the socket for pushing the tool bit.

10. The chuck device according to claim 9 including a ring attached to the socket, wherein the first elastic element is compressed between the ring and the sleeve.

11. The chuck device according to claim 10 wherein the sleeve includes an annular rib formed on an internal face, wherein the elastic element is compressed between the ring and the annular rib.

12. The chuck device according to claim 10 including a ring fit in the sleeve for abutting the ring attached to the socket so as to retain the sleeve on the socket.

13. The chuck device according to claim 9 wherein the socket includes an internal face with six facets and six corners.

14. The chuck device according to claim 13 wherein the socket includes six apertures each defined in one of the corners of the internal face of the socket.
